(19) United States
(12) Patent Application Publication
(10) Pub. No.: US 2018/0267310 A1
(43) Pub. Date: Sep. 20, 2018

(54) COMBINER HEADS-UP DISPLAY

(71) Applicant: Continental Automotive Systems, Inc., Auburn Hills, MI (US)

(72) Inventors: Luis Ernesto Quiroz de la Mora, Tlaquepaque (MX); Johan Gomez Martinez, Zapopan (MX)

(21) Appl. No.: 15/460,811

(22) Filed: Mar. 16, 2017

(51) Int. Cl. G02B 27/01; B60K 37/02

(52) U.S. Cl. CPC G02B 27/0149; G02B 2027/0154; B60K 2350/352; B60K 37/02

(57) ABSTRACT

A combiner head up display can be manually lowered into a vehicle's dash board by a spring-loaded retractable lock attached to a support plate. The lock is located near the end of a slot in the support plate and provides a bias force to a locating pin that keeps the pin and mirror up until the latch portion of the lock is manually pushed back into the lock.

### BACKGROUND

A heads-up display (HUD) is a device that projects images such as a speedometer or lane change indicator onto the inside surface of a vehicle's windshield. The projected image is created by mirrors such that the driver perceives the projected image as floating in the air a short distance (1-2 meters) away from his or her eyes.

Prior art heads-up display systems that project the image onto a windshield are complicated by a windshield's curvature. In order to have the projected image appear without distortion on a curved surface, the projected image must be compensated by the image source and projecting mirrors to compensate or overcome image distortion caused by the windshield surface's curvature.

A combiner heads-up display (C-HUD) is a device that performs essentially the same function as a heads-up display that projects images onto a windshield, except that the projected image of a C-HUD is not on the windshield but on an acrylic plastic panel called a “combiner mirror.”

FIG. 1, shows a small, clear acrylic combiner mirror in its extended position, i.e., above the vehicle's dashboard, where it displays images within the driver's field of vision without having to project it onto the windshield. A principal advantage of the combiner heads-up display is its windshield-shape independency. And, the same image projection mechanism can be used in different cars having different windshield shapes. Another advantage is its relatively simple manufacturing. Since the reflective surface in the C-HUD is the substantially planar combiner mirror, other optical layers can be reduced to small plastic planar mirrors making the device easier to manufacture and less expensive.

A disadvantage of a combiner heads-up display is that it must be moved upwardly from inside the dashboard when it is turned on. It must also be retracted back into the dashboard when it is turned off in order to reduce the likelihood of damage and reduce the aging effects caused by prolonged exposure to the sun. The extension and retraction of the C-HUD is provided by a 12V DC motor and gearbox.

In the prior art, a combiner mirror of a C-HUD is locked in an upward and extended position by a mechanical lock that does not allow the combiner mirror to be returned to its stowed position if the DC power source fails or is cut off. A combiner heads-up display (C-HUD) that enables the combiner mirror to be manually stowed, i.e., pushed back into the vehicle's dashboard, when the power is off would be an improvement over the prior art.

### BRIEF DESCRIPTION OF THE FIGURES

FIG. 1 is a perspective view of a combiner heads-up display with a manually-operable lock that will allow the mirror to be manually retractable;

FIG. 2 is a perspective view of a combiner heads-up display with a manually-operable lock;

FIG. 3 is an exploded view of the combiner heads-up display shown in FIG. 1;

FIG. 4 is a side view of the device shown in FIG. 1;

FIG. 5 is a perspective view, which shows the combiner heads-up display unit of FIG. 1 in a partially extended position;

FIG. 6 is a perspective view, which shows the combiner heads-up display in a fully extended position;

FIG. 7 is an enlarged view of the retractable lock mechanism shown at its extended position holding the combiner mirror elevation guide pin in place;

FIG. 8 is an enlarged view of the retractable lock mechanism in its retracted position;

FIG. 9 is an enlarged view of the retractable lock mechanism showing a small leaf spring configured to eliminate or reduce vibration of the lock mechanism in the combiner heads-up display; and,

FIG. 10 is a sectional view of the retractable lock mechanism.

### DETAILED DESCRIPTION

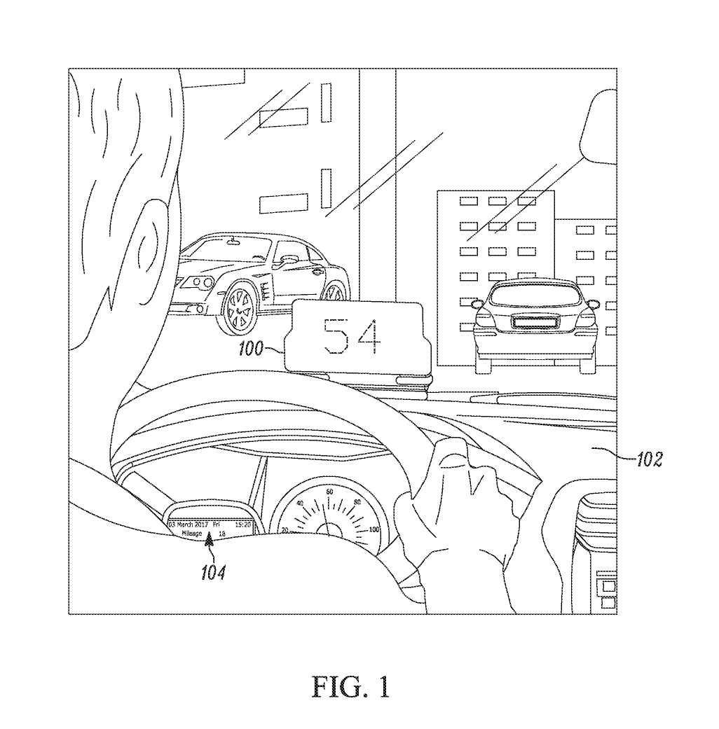

FIG. 1 depicts a combiner heads-up display 100 (C-HUD) extending upwardly from the dashboard 102 of a motor vehicle. The digits “54” can be seen on the C-HUD 100 without having to look directly at the vehicle's speedometer 104 and away from the roadway in front of the vehicle.

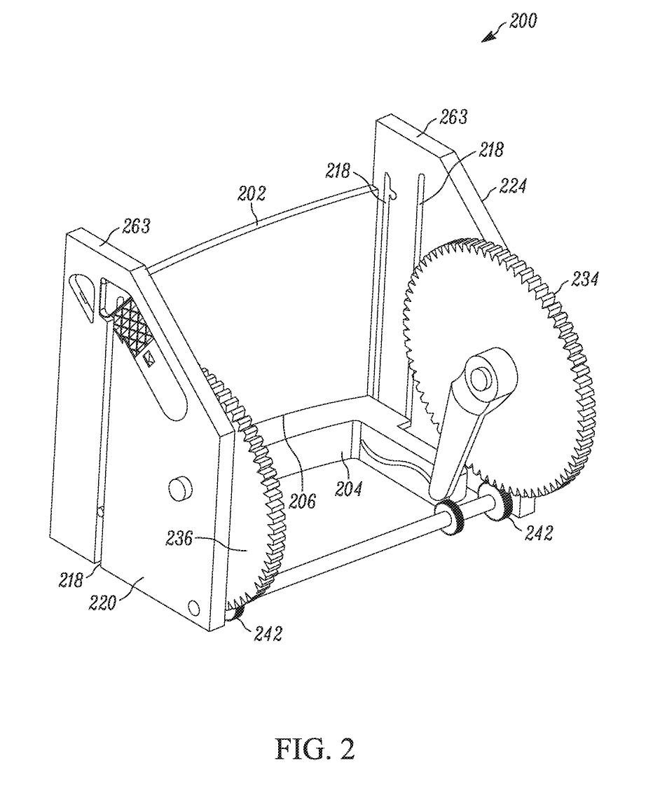

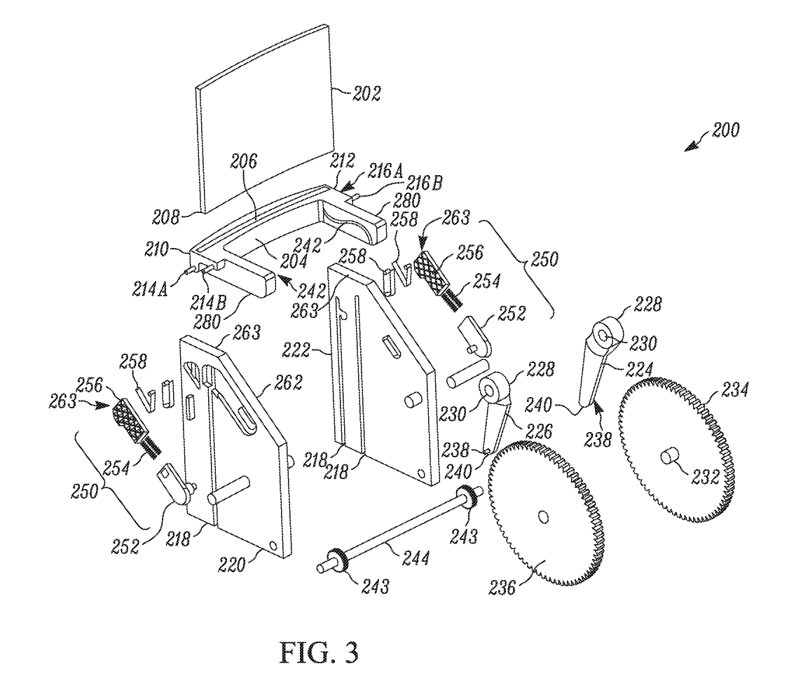

FIG. 2 is a perspective view of the combiner heads-up display device 200. The combiner mirror 202, which is a substantially planar transparent plastic, and shown in its retracted position, is affixed to a combiner mirror holder 204. The mirror holder 204 has a slot 206 that is sized, shaped and arranged to receive the bottom edge 208, shown in FIG. 3, of the combiner mirror 202 therein.

FIG. 3 is an exploded view of the combiner heads-up display 200. The combiner mirror holder 204 has two opposite ends, 210 and 212. It also has two, substantially parallel, substantially horizontal lifting arms 280 that extend away from the mirror holder 204 and substantially orthogonal thereto.

Each end 210, 212 of the combiner mirror holder 204 has two elevation pins 214A, 214B and 216A and 216B. The elevation pins 214A, 214B, 216A and 216B are “attached to” and extend from from the corresponding ends 210 and 212 of the mirror holder 204.

The elevation pins are preferably cylindrical or columnar. They are sized and shaped to freely slide up and down substantially vertical elevation slots 218 formed into two substantially parallel, substantially vertical, substantially planar support plates 220 and 222.

The space between the support plates 220 and 222 is slightly greater than the width of the mirror holder 204 but less than the combined width of the mirror holder 204 plus the elevation pins. The combiner mirror 202 can thus be raised and lowered between the support plates 220 and 222 by raising and lowering the combiner mirror holder 204 as the elevation pins 214A, 214B and 216A and 216B “ride” in the elevation slots 218.

The combiner mirror holder 204 is raised and lowered by two substantially parallel, substantially horizontal elevation arms 224 and 226 that engage the lifting arms 280 extending away from and toward main gears 234, 236. The elevation arms 224, 226 have first and second opposing ends, one of which is identified by reference numeral 228 and which is provided with cylindrical opening 230 sized, shaped and arranged to fit onto small shafts 232 that extend inwardly from opposing, spaced-apart main gears 234 and 236. The elevation arms 224 and 226 are fixed to the shafts 232 such that rotation of the main gears 234, 236 causes the elevation arms 224 and 226 to rotate with the main gears, 234, 236.

Short pins 238 at the second end 240 of the elevation arms 224, 226 are sized, shaped and arranged to engage opposing and substantially-horizontal lift slots 242 that are formed into the two, substantially parallel, substantially horizontal lifting arms 280 that extend away from the mirror holder 204. The lift slots 242 are sized shaped and arranged to allow the pins 238 to traverse laterally (substantially horizontally) in the lift slots 242 as the arms 224 and 226 rotate clockwise and counter-clockwise with the main gears. Rotation of the arms 224, 226 thus causes the pins 238 to move laterally and vertically relative to the lift slots 242. Vertical movement of the pins 238 causes the substantially horizontal lifting arms 280 and the mirror holder to which they are connected, to rise.

The main gears 234, 236 are rotatably fixed to the support plates 220 and 222. The main gears 234, 236 are driven by two smaller mating gears 243 that are attached to a rotating drive shaft 244 which is also rotatably fixed between the vertical support plates 220, 222. A small D.C. motor (not shown) which is of course reversible, is geared to the drive shaft 244. By energizing the motor and controlling the polarity of the voltage provided to it, the drive shaft and small gears 243 can be rotated in opposite directions causing the main gears to rotate in opposite directions causing the mirror holder 204 and mirror 202 to go up or down.

Manually operable and retractable lock mechanism assemblies 250 (one assembly 250 in each support plate 220, 222) comprise an essentially hollow “follower” body 252, two coil springs 254 inside the follower body 252, and a substantially square-shaped latch 256 having a beveled or “mitred” corner portion 265. A leaf spring assembly 258, separate and apart from the retractable lock assemblies 250, reduces vibration of corresponding retractable lock assemblies 250.

The retractable lock mechanism assemblies 250 fit slidably into a recess 262 formed near the top edge 263 of the support plates 220 and 222.

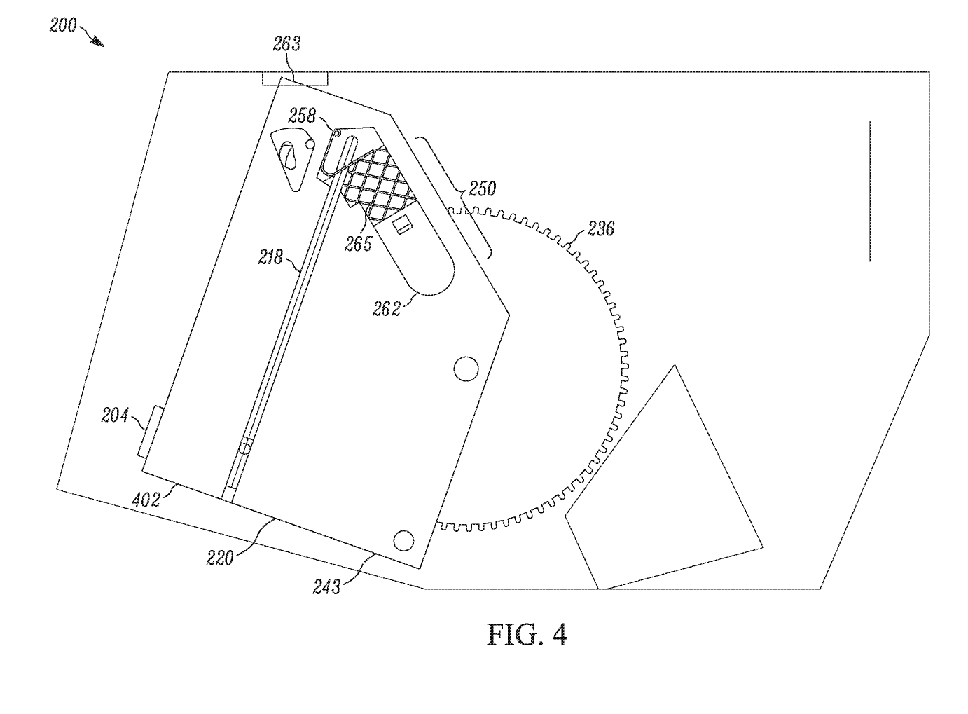

FIG. 4 is a side view of the combiner heads-up display assembly 200. The left side main gear 236 is shown in a “first” position whereat the combiner mirror holder 206 is located at or near the bottom edge 402 of the vertical support plates 220, 222. The elevation pins 214 extend through a slot 218 in the left support plate 220.

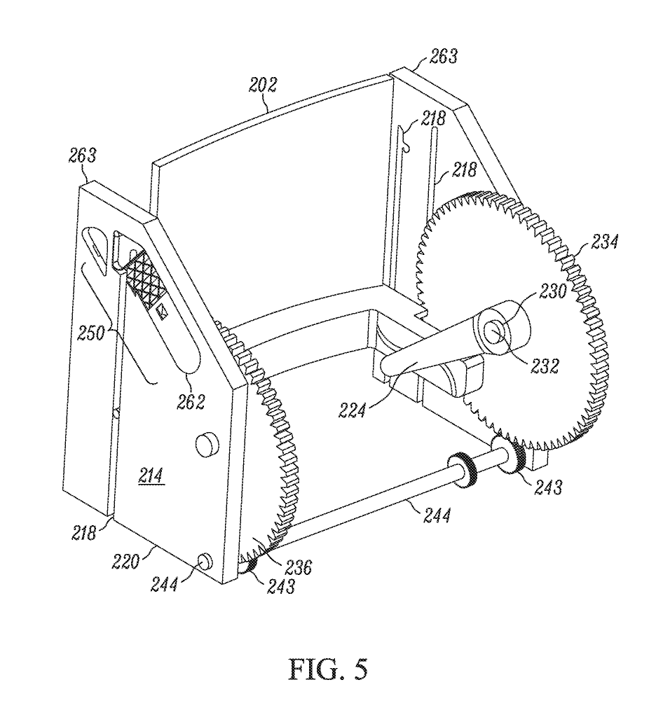

FIG. 5 is a perspective view of the combiner heads-up display showing the combiner mirror 202 in a partially elevated or “second” position. The elevation pins, one visible in the left support plate 220 is partway up the elevation rail slot 218 formed in the left-side support plate.

The right-side elevation arm 224, shown at an angle of approximately 45 degrees relative to horizontal, is extended laterally, partway along the slot 242 formed in the right-side of the combiner mirror holder 204.

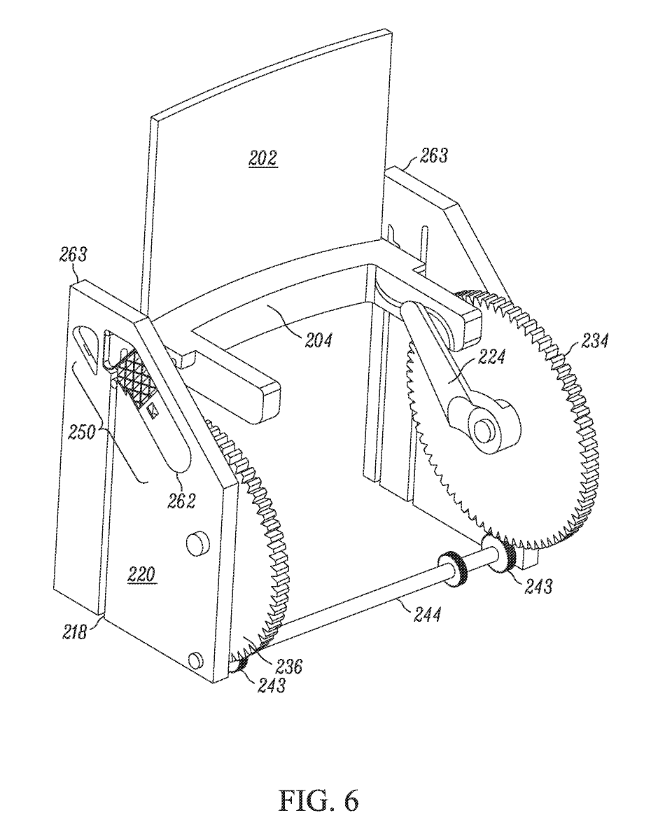

FIG. 6 is a perspective view of the combiner heads-up display 200 in its extended position. The elevation arms are rotated further on the main gears 236 and 234. Similarly, the elevation pins 214 (one shown) is near the top of the elevation rail/slot 218.

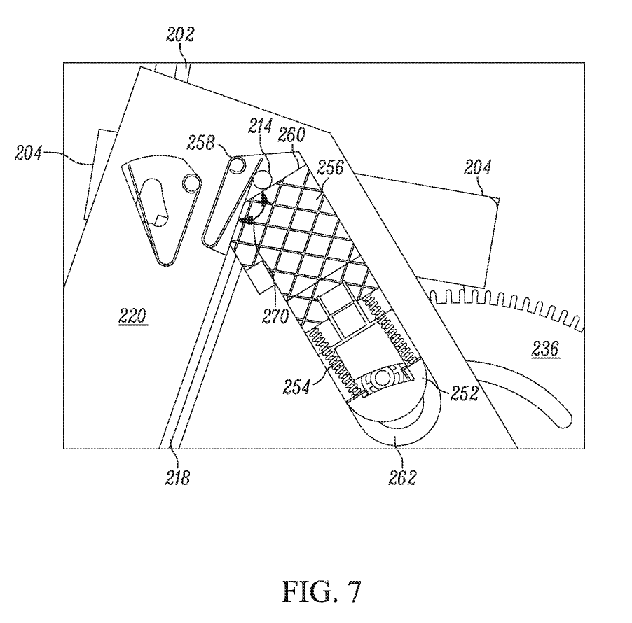

Referring now to FIG. 7, an enlarged view of the retractable lock assembly 250 shows the left-side guide pin 214 at the top of the elevation rail/slot 218. The substantially square-shaped latch 256 is biased outwardly from the follower body 252 by two coil springs 254. The leaf spring assembly 258 in each support plate, biases the elevation guide pin 214 against the top end 263 of the latch 256.

A mitred or beveled corner portion 265 of the top 260 of the substantially square-shaped latch 256 is inclined at an angle (angle 270 is preferably between about 120 and 160 degrees) or “mitred” relative to the top 260 and the slot 218 (at different angles of course). The angle of the mitre permits the guide pin 214 to be slid downwardly in the elevation rail/slot 218 by pushing downwardly on the combiner mirror 202. The mitred or beveled portion 265 of the top 260 enables the latch 256 to move within the recess 262 formed in the support plate 220 and into and out of the follower body 252.

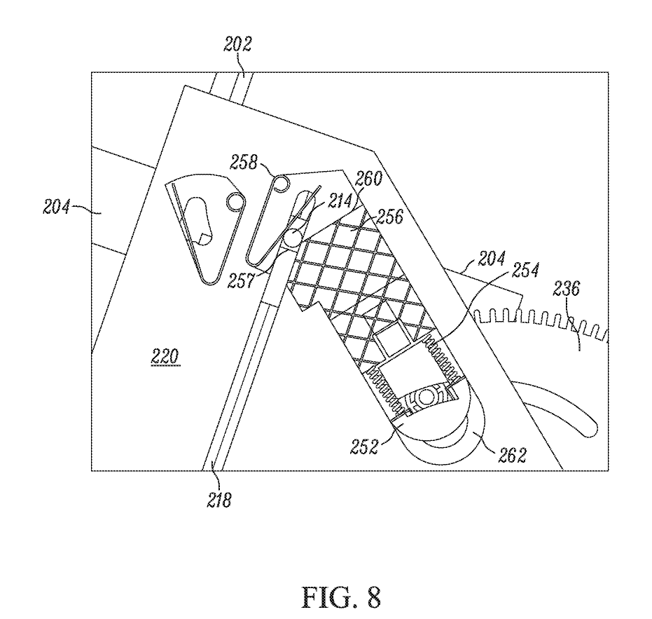

FIG. 8 shows the structure depicted in FIG. 7 but with the elevation guide pin 214 pushed farther down the elevation rail/slot 218.

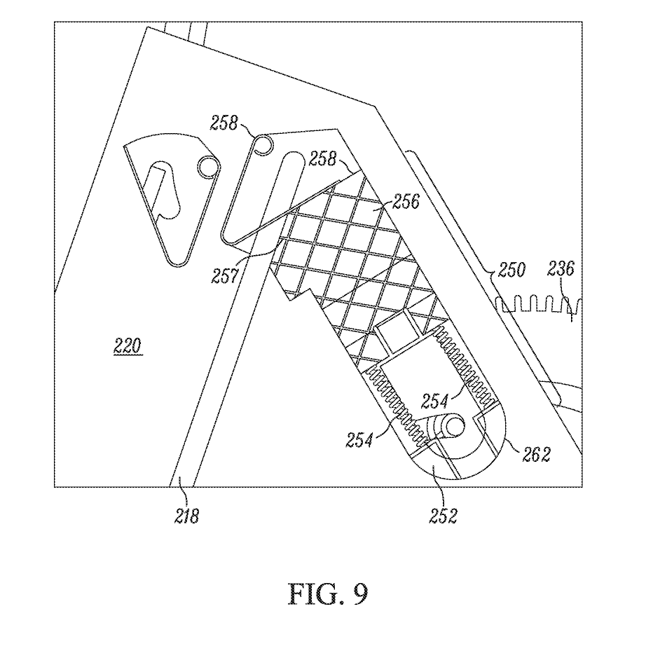

FIG. 9 shows the retractable lock assembly 250 fully extended in the recess 262 with the leaf spring 258 applying a slight compressive force to the latch, keeping it from rattling.

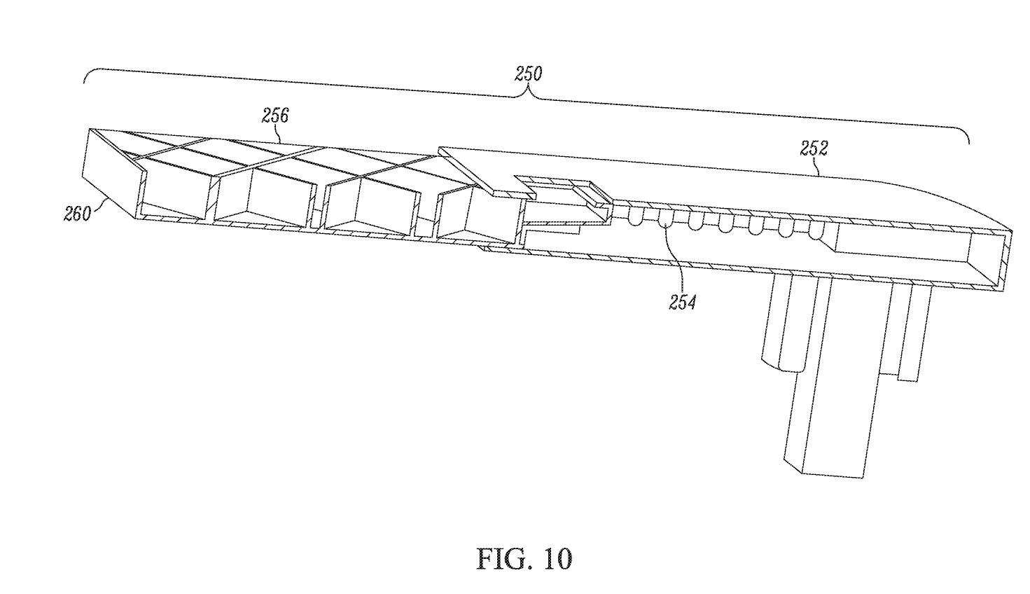

Finally, FIG. 10 is a sectional view of the retractable lock assembly 250, namely, the square-shaped latch partially inside the follower body 252. FIG. 10 also shows one of the two coil springs 254 inside the follower body 252 such that it will exert an outwardly-directed bias force against the latch 252.

Those of ordinary skill in the art should recognize that the spring-loaded, manually operable retractable lock mechanism of the a combiner heads-up display allows the combiner mirror to be pushed back down into the vehicle's dashboard manually, even when there might not be any power available and which would require the combiner mirror to remain in its upright position.

The foregoing description is for purposes of illustration only. The true scope of the invention is set forth in the following claims.

What is claimed is:

1. A manually retractable combiner head up display comprising:
a spring-loaded retractable lock assembly attached to a support plate and proximate to a top end of a slot formed in the support plate, the retractable lock having a forwardly-extended engaged position and an a retracted open position, the spring-loaded retractable lock assembly being configured to:
hold an elevation control pin near the top end of the slot when the retractable lock is in the forwardly-extended engaged position; and
permit an elevation control pin to drop downwardly through the slot when the retractable lock is in the retracted open position.

2. A manually retractable combiner head up display comprising:
a substantially planar combiner mirror having a first width;
a combiner mirror holder comprising:
first and second opposing ends;
a second width, defined by the distance between the first and second opposing ends;
mirror holder elevation control pins, (elevation control pins) each elevation control pin having a corresponding outside diameter, first and second opposing ends and a corresponding length defined by the distance between the first and second opposing ends, the first end of the first elevation control pin being attached to the first end of the combiner mirror holder, the first end of the second elevation control pin being attached to the second end of the combiner mirror holder, the distance between the second ends of the first and second elevation control pins defining an overall width of the combiner mirror holder and the first and second mirror holder elevation control pins, each of the elevation control pins having a corresponding central axis, the central axes of the elevation control pins being substantially co-linear;
first and second substantially planar support plates, said support plates being substantially vertical and spatially separated from each other by a distance greater than the second width but less than the overall width of the combiner mirror holder and the first and second mirror holder elevation control pins, each planar support plate comprising a slot, sized, shaped and arranged to receive an elevation control pin, each slot having a top end, bottom end and a width greater than the outside diameter of the elevation control pin received therein; and
a spring-loaded retractable lock attached to a support plate, proximate to the top end of the slot in the support plate, the retractable lock having a forwardly extended closed position and an a retracted open position, the retractable lock being configured to:
hold an elevation control pin near the top end of the slot when the retractable lock is in the forwardly extended closed position; and
permit an elevation control pin to drop downwardly through the slot when the retractable lock is in the retracted open position.

3. The manually retractable combiner head up display of claim 2, wherein the spring-loaded retractable lock comprises a follower, sized, shaped and arranged to travel between first and second positions in an inclined second slot formed in the support plate, responsive to force applied to the follower by a rotating gear located between the first and second support plates.

4. The manually retractable combiner head up display of claim 3, wherein the spring-loaded retractable lock additionally comprises a latch having a top end, which is mitred.

5. The manually retractable combiner head up display of claim 4, further comprising a leaf spring configured to exert a bias force against the top end of the latch.

6. The retractable combiner head up display of claim 5, wherein each of the support plates comprise a recess configured to slidably receive the spring-loaded retractable lock.
